(19) United States
(12) Patent Application Publication
(10) Pub. No.: US 2011/0242128 A1
(43) Pub. Date: Oct. 6, 2011

(54) USER'S PREFERENCE APPLIED FEELING-BASED IMAGE COLOR CONTROL METHOD USING INTERACTIVE GENETIC ALGORITHM

(75) Inventor: Hang-Bong KANG, Seoul (KR)

(73) Assignee: CATHOLIC UNIVERSITY INDUSTRY ACADEMIC COOPERATION FOUNDATION, Seoul (KR)

(21) Appl. No.: 13/074,429

(22) Filed: Mar. 29, 2011

(30) Foreign Application Priority Data
Apr. 1, 2010 (KR) 10-2010-0029668

(51) Int. Cl. G09G 5/02

(52) U.S. Cl. 345/594

(57) ABSTRACT

A method is provided that controls the color of a feeling-based image reflecting a user's preference via an interactive genetic algorithm. The method is performed in such a manner that a range of candidate colors is defined by type of feelings as templates, one from among the candidate templates, as the final template, is selected by learning a user's color preference via an interactive genetic algorithm, and then the color of an image is controlled based on the final template by recognizing a user's feeling.

### PRIORITY

This application claims the benefit under 35 U.S.C. §119(a) of a Korean patent application filed on Apr. 1, 2010 in the Korean Intellectual Property Office and assigned Serial No. 10-2010-0029668, the entire disclosure of which is hereby incorporated by reference.

### BACKGROUND OF THE INVENTION

1. Field of the Invention

The present invention relates to color controlling methods. More particularly, the present invention relates to a method for controlling the color of a feeling-based image reflecting a user's preference via an interactive genetic algorithm.

2. Description of the Related Art

Color affects people's feeling. Many scholars have researched the relationships between color and feeling, psychology, emotion, individuality, etc. In particular, R. Plutchik, a psychologist, mentioned the relationship between color and eight basic feelings, for example yellow shows bright and positive emotion, blue shows melancholy and sorrow, etc. However, reaction to color may vary according to human races, culture, age, sex, etc. Therefore, a great deal of research has focused on analyzing the relationship between color and feeling and ascertained that people may have different feelings about the same color. As such, since people have different feelings about colors according to their preferences, environments, etc., the relationship between color and feeling may vary from person to person.

Hue templates have been used to research a combination of colors. They have also used to show a combination of natural hues by shifting a hue on an image using a numeric formula. In recent years, they have been applied to motion pictures as well as still images, thereby achieving a combination of hues in various areas. Although convention hue templates have been defined and applied to various areas related to a combination of hues, they have not defined the relationship between color and feeling.

Colors are described in terms of hue, saturation and brightness (or value). Saturation and brightness also affect people's feelings. However, conventional research has just proposed a numeric formula for controlling hue and showed the result, without controlling saturation and brightness.

Conventional color transformations are performed in such a manner that a template is selected and then a corresponding color is simply controlled. However, although people's reactions about colors differ according to their preferences and environments, so that the relationship between color and feeling may thus be variously defined, conventional color transformation methods do not take this relationship into consideration, and thus do not satisfy users with the finally controlled color.

### SUMMARY OF THE INVENTION

Aspects of the present invention are to address the above-mentioned problems and/or disadvantages and to provide at least the advantages described below. Accordingly, an aspect of the present invention is to provide a method for controlling the color of an image based on a user's feeling that can establish a relationship between color and feeling by defining color templates related to feelings, and can thus control color according to a user's feelings.

Another aspect of the present invention is to provide a method for controlling the color of an image based on a user's feeling that can define hue, saturation, and brightness templates, and can effectively reflect a user's feeling regarding an image by controlling hue, saturation and brightness.

Another aspect of the present invention is to provide a method for controlling the color of an image based on a user's feeling that can apply an interactive genetic algorithm to a color controlling process in order to reflect the color preference of a user, can learn a combination of a user's preferred templates, and can select a combination of final hue, saturation and brightness templates, thereby retaining a user's interest and absorption via the interactive process.

In accordance with an exemplary embodiment of the invention, a method for controlling the color of a feeling-based image is provided. The method includes (1) defining a range of candidate colors by type of feelings as templates, (2) selecting one from among the candidate templates, as the final template, by learning a user's color preference via an interactive genetic algorithm, and (3) controlling the color of an image based on the final template by recognizing a user's feeling.

Preferably, the definition of a range of candidate colors comprises analyzing a relationship between color and feeling to determine a range of color reflecting respective feelings, and defining the analyzed result as templates representing a range of colors corresponding to the respective feelings. The defined templates form a number of candidate templates to reflect the variety of relationship between color and feeling.

Preferably, each of the candidate templates comprises seven hue templates, four saturation templates, and four brightness templates.

Preferably, the selecting of one from among the candidate templates comprises creating an initial individual by selecting one of the defined templates, controlling the color of an image by applying the initial individual thereto, and displaying the color controlled image, receiving a user's estimated value regarding the displayed color controlled image via a user interface, and selecting an individual to hand over to the next generation by selecting a tournament according to the user's level of image satisfactions and by using an elitism, computing a one point cross with respect to a parent individual, and creating a variation by changing a bit, and determining a combination of hue, saturation, and brightness templates for the final individual reflecting a user's preference.

Preferably, the controlling of the color of an image comprises controlling saturation and brightness by a gamma correction of an exponential transformation function as a nonlinearity function.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a view that describes a method for controlling the color of a feeling-based image based on a user's preference via an interactive genetic algorithm, according to an exemplary embodiment of the present invention;

FIG. 2 illustrates a flow chart that describes a method for controlling color of a feeling-based image reflecting a user's preference via an interactive genetic algorithm, according to an exemplary embodiment of the present invention;

FIGS. 3A to 3D illustrate hue, saturation, and brightness templates with respect to pressure, sorrow, anger, and fear, respectively, according to an exemplary embodiment of the present invention;

FIG. 4 illustrates a template borrowing an expression of a chromosome, according to an exemplary embodiment of the present invention;

FIG. 5 illustrates a view that describes a process of selecting one of the candidate templates, as the final template, by learning a user's color preference via an interactive genetic algorithm, according to an exemplary embodiment of the present invention;

FIG. 6 illustrates a user interface according to an exemplary embodiment of the present invention;

FIG. 7A illustrates a view that describes a process of creating the next generation via a crossover operation, according to an exemplary embodiment of the present invention;

FIG. 7B illustrates a view that describes a process of creating the next generation via a variation operation, according to an exemplary embodiment of the present invention;

FIG. 8 is a plot of the average of suitability vs. generations with respect to feelings according to an exemplary embodiment of the present invention; and

FIG. 9 is a diagram that shows a color controlled image preference for the four feelings, at upper part, and a color controlled image preference by feelings according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this application, it will be understood that when an element is referred to as being “connected” or “coupled” to another element, it can be directly connected or coupled to the other element or intervening elements may be present. It will be further understood that the terms “includes,” “comprises,” “including” and/or “comprising,” specify the presence of stated features, integers, steps, operations, elements, and/or components, but do not preclude the presence or addition of one or more other features, integers, steps, operations, elements, components, and/or groups thereof.

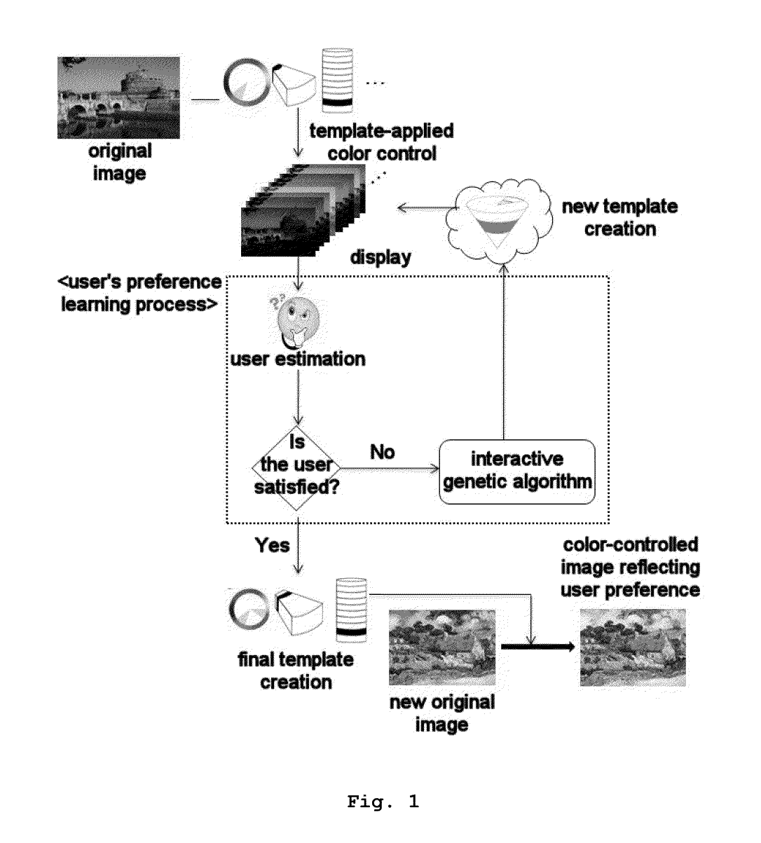

FIG. 1 illustrates a view that describes a method for controlling the color of a feeling-based image based on a user's preference via an interactive genetic algorithm, according to an exemplary embodiment of the present invention.

Referring to FIG. 1, a template is applied to an original image, thereby producing a color controlling process. The color controlled original image is displayed. When the user inputs his/her estimated value for the displayed color-controlled image, the color controlling method determines whether the user is satisfied with the color-controlled image according to the user's input value. When the user is not satisfied with the color-controlled image, the method creates a new template via an interactive genetic algorithm, applies it to the image, and displays the result, so that the user re-inputs his/her estimated value for the displayed image. When the method ascertains that the user is satisfied with the displayed image, based on the user's input value, it creates the template applied to the image, as the final template. After that, when a process displays a new image, the final template is applied to the new image, thereby creating a color controlled image reflecting the user's preference. Therefore, the color control method can allow a user to control the color of an image to meet his/her preference, thereby increasing a user's level of image satisfaction.

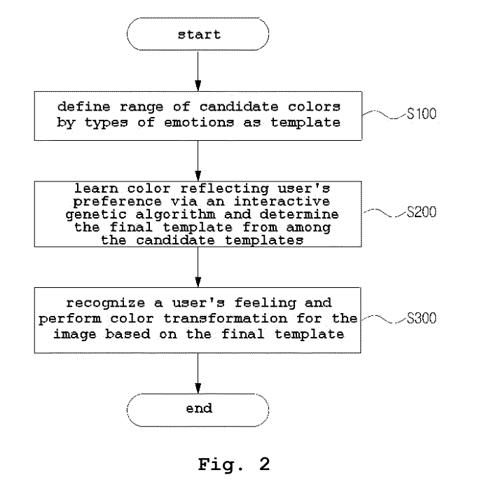

FIG. 2 illustrates a flow chart that describes a method for controlling the color of a feeling-based image reflecting a user's preference via an interactive genetic algorithm, according to an exemplary embodiment of the present invention.

Referring to FIG. 2, the color controlling method is performed in such a manner that a range of candidate colors according to types of feelings is defined as templates at step S100, one from among the candidate templates, as the final template, is selected by learning a color based on a user's preference via an interactive genetic algorithm at step S200, and the color of an image is controlled based on the final template by recognizing a user's feeling at step S300.

The range of candidate colors is defined, at step S100, in such a manner that a relationship between color and feeling is analyzed to determine a range of colors reflecting respective feelings at step S110, and the analyzed result is defined as templates representing a rand of color corresponding to the respective feelings at step S120. The defined templates form a number of candidate templates to reflect the variety of relationships between color and feeling.

The analysis of a relationship between color and feeling, at step S110, may be performed by analyzing the general reaction of people about color. To do this, a questionnaire survey may be conducted to reflect a variety of feelings about colors according to human race, cultural background, environments, etc. There are various types of feelings for example anger, hatred, fear, happiness, sorrow, surprise, etc., each of which may be used to analyze the relationship between color and the feeling. In the following embodiment, the feelings used to analyze the relationship between color and feeling will employ four feelings that may be commonly shared based on different cultures and languages, i.e., pleasure, sorrow, anger, and fear. Although the embodiment is described based on the four feelings, it should be understood that the invention is not limited to the embodiment. That is, the embodiment may be modified in such a manner to employ other feelings.

In an embodiment of the invention, after a questionnaire survey is conducted in such a manner that it shows a certain number of pictures to people targeted by a questionnaire survey and collects feelings that the people experience from the colors used in the pictures, a range of primary colors related to feelings is extracted from the highest ranked picture to the next picture in the following order. In order to perform an effective extraction, the HSV space of each picture may be quantized by ten as described in the following table 1. In addition, a histogram of the most popular picture with the greatest number of replies is acquired and then the maximum range in the histogram value for each image is also acquired. In an embodiment of the invention, the number of the most frequently shown ranges, from the ten highest ranking images, by hue, saturation and brightness is at least three. The three, most frequently shown ranges can be shown as in the following table 2.

TABLE 1

| Index | Range of hue (unit: °) | Range of saturation | Range of brightness |
|---|---|---|---|
| 0 | 342-360, 0-18 | 0-0.1 | 0-0.1 |
| 1 | 18-54 | 0.1-0.2 | 0.1-0.2 |
| 2 | 54-90 | 0.2-0.3 | 0.2-0.3 |
| 3 | 90-126 | 0.3-0.4 | 0.3-0.4 |
| 4 | 126-162 | 0.4-0.5 | 0.4-0.5 |
| 5 | 162-198 | 0.5-0.6 | 0.5-0.6 |
| 6 | 198-234 | 0.6-0.7 | 0.6-0.7 |
| 7 | 234-270 | 0.7-0.8 | 0.7-0.8 |
| 8 | 270-306 | 0.8-0.9 | 0.8-0.9 |
| 9 | 306-342 | 0.9-1.0 | 0.9-1.0 |

TABLE 2

| | Pleasure | Sorrow | Anger | Fear |
|---|---|---|---|---|
| Hue index | 1, 2, 3 | 0, 4, 6 | 0, 1, 4 | 1, 3, 7 |
| Saturation index | 0, 3, 9 | 0, 1, 6 | 0, 6, 9 | 0, 1, 9 |
| Brightness index | 7, 8, 9 | 0, 6, 9 | 0, 7, 9 | 0, 1, 6 |

Meanwhile, the definition of the analyzed result as templates representing a range of color corresponding to the respective feelings, at step S120, is to build templates for hue, saturation and brightness via the HSV color space most similar to a human color recognition method. Since every person experiences different feelings about a particular color range, it is preferable to have various types of templates to reflect this variety.

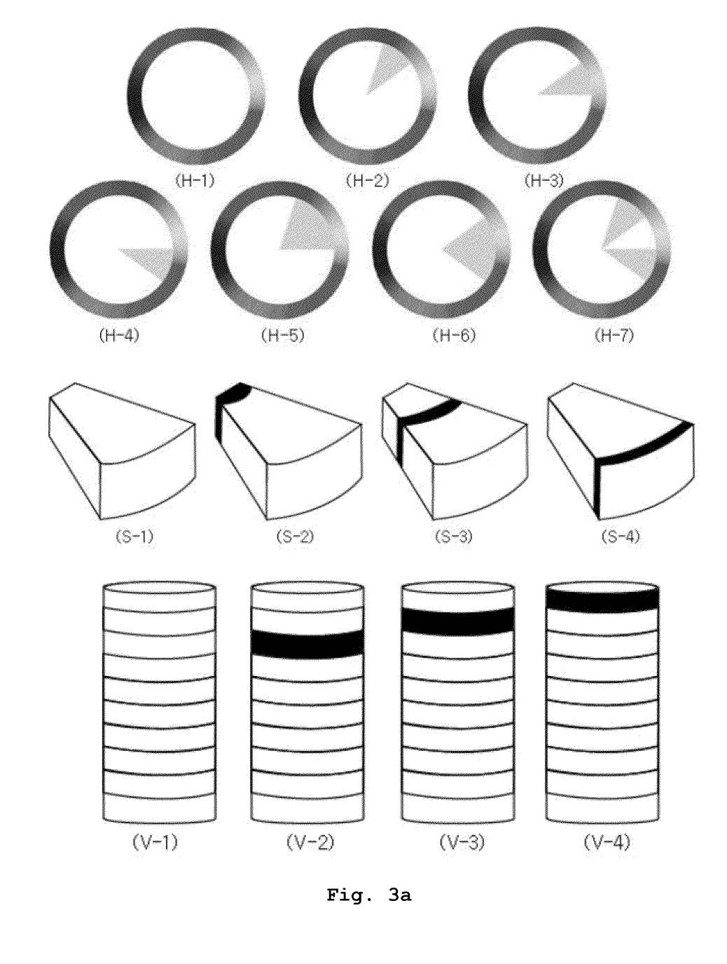

FIGS. 3A to 3D illustrate hue, saturation, and brightness templates with respect to pressure, sorrow, anger, and fear, respectively, according to an exemplary embodiment of the present invention.

Referring to FIGS. 3A to 3D, the templates may be comprised of seven templates for hue to form a combination of hues and four templates of saturation and brightness, respectively. However, respective templates may be formed variously according to the relationship between the analyzed color and feeling. For example, color is divided into a distribution of hue and tone (saturation and brightness), and then the templates are formed based on eight types of hues and ten types of tones. Referring to FIGS. 3A to 3D, the grey sector corresponds to the range of hues according to the result described in table 2. In particular, the hue template may be formed to have two sectors by combining three ranges described in table 2.

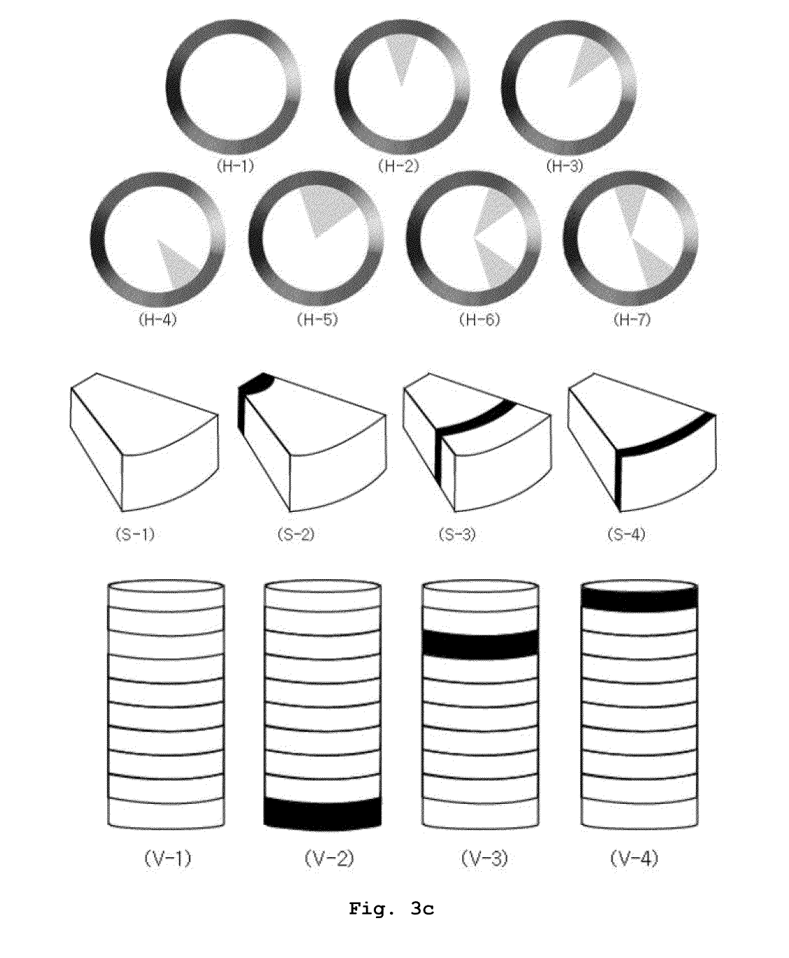

The final template can be selected from among the candidate templates, at step S200, in such a manner that, since people experience different feelings about hue, saturation and brightness, a user's preference is learned and the learned user's preference is reflected by color. An interactive genetic algorithm is employed to learn a user's preference. The interactive genetic algorithm is mutually interacted with a user, thereby increasing the satisfaction of a user's feeling with respect to the finally controlled result and also creating templates by types of feelings, which can be satisfied by the user. The selection of the final template via the interactive genetic algorithm will be described in detail later, referring to FIG. 5.

The controlling of the color of an image based on the final template, at step S300, can be performed in such a manner that color is moved to a particular range by applying a numerical formula to a predefined template and thus the color control is applied to the image. The controlling of color in an image is performed by controlling hue values at step S310 and by controlling saturation and brightness values at step 320.

The controlling of hue values, at step S310, needs to be performed by retaining as much as possible of the original hue in order to acquire a natural hue controlled result. To this end, a Gaussian function can be employed. In an embodiment of the invention, a linear hue movement according to the distance from the center cell in the sector, using a Gaussian function, as shown in FIGS. 3A to 3D, can be defined as the following equation 1. That is, the hue value of the pixel p is moved to the sector of a corresponding template via the following equation 1.

$${H}^{′} ( p ) = {H}_{c} ( p ) + \frac{u}{2} ( 1 - {G}_{σ} ( ‖ H ( p ) - {H}_{c} ( p ) ‖ ) ) \qquad Equation 1$$

Wherein Hc(p) is defined as the center hue value of the sector. u denotes an arc length of a template sector, and Ga denotes a Gaussian function where the average is zero and the standard deviation is σ. The range of a may be defined 0˜u by a user. If σ is large, the hue value is closer to the center in the sector. On the contrary, if σ is small, the hue value is closer to the boundary in the sector. In order to acquire the optimal hue valance, σ may be u/2. When the number of sectors is two or more, the hue value is moved to a sector where the distance between a current pixel and the center of the sector is relatively close.

The controlling of saturation and brightness values, at step 320, may be performed via an image process algorithm for correcting non-linear reactions. Since people's eyes have a non-linearity where the eyes cannot recognize dark or unclear colors, saturation and brightness would be adjusted to follow the non-linearity rather than just added or subtracted by a certain value. To this end, the image process algorithm is employed to correct the non-linear reactions. The image process algorithm may be performed by a gamma correction by an exponential transformation function, as a non-linear function, and is expressed by the following equation.

Since the number of the exponential function has a range of [0, 1], the input is divided by 255 and the output is multiplied by 255. Gamma value is set by a user or has been set by the manufacturer. In an embodiment of the invention, the gamma value corresponding to each quantization range is calculated and then applied thereto. The gamma correction formula is applied by inputting pixel values, 0˜255, and varying a gamma value from γ1 to γ2. A gamma value is selected to maximize the number of pixels corresponding to each quantization range. Saturation and brightness values of an input can be converted to a range defined in a template, by the selected gamma value.

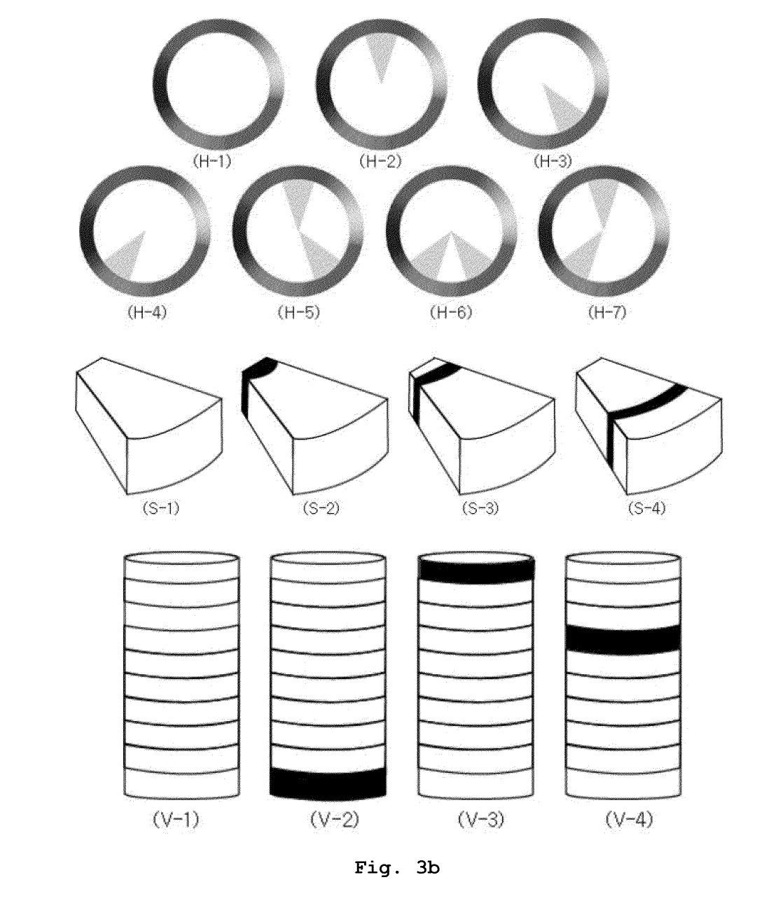

FIG. 4 illustrates a template borrowing an expression of a chromosome, according to an exemplary embodiment of the present invention.

Referring to FIG. 4, an individual used in the interactive genetic algorithm may be expressed as a chromosome representing respective templates. For example, as shown in FIGS. 3A to 3D, since each template is comprised of seven templates for hue and four respective templates for saturation and brightness, hue of 3 bits, saturation of 2 bits, and brightness of 2 bits may be encoded. The encoding of templates by respective feelings may be expressed as in the following table 3. Although FIG. 4 and table 3 express the configuration of templates as a chromosome for the sake of convenient description, it should be understood that the number of chromosomes may vary according to the types and number of templates.

TABLE 3

| Hue | | Saturation | | Brightness | |
|---|---|---|---|---|---|
| Template | Encoding | Template | Encoding | Template | Encoding |
| H-1 | 000 | S-1 | 00 | V-1 | 00 |
| H-2 | 001 | S-2 | 01 | V-2 | 01 |
| H-3 | 010 | S-3 | 10 | V-3 | 10 |
| H-4 | 011 | S-4 | 11 | V-4 | 11 |
| H-5 | 100 | | | | |
| H-6 | 101 | | | | |
| H-7 | 110 | | | | |

FIG. 5 illustrates a view that describes a process (S200) of selecting one of the candidate templates, as the final template, by learning a user's color preference via an interactive genetic algorithm, according to an exemplary embodiment of the present invention.

Referring to FIG. 5, the selecting of the final template, at step S200, comprises an initial individual creation and display at step S210, a user estimation and selection at step S220, a next generation creation by computing a cross and variation at step S230, and a determination of a combination of hue, saturation and brightness templates, serving as the final individual, based on a user's preference at step 240.

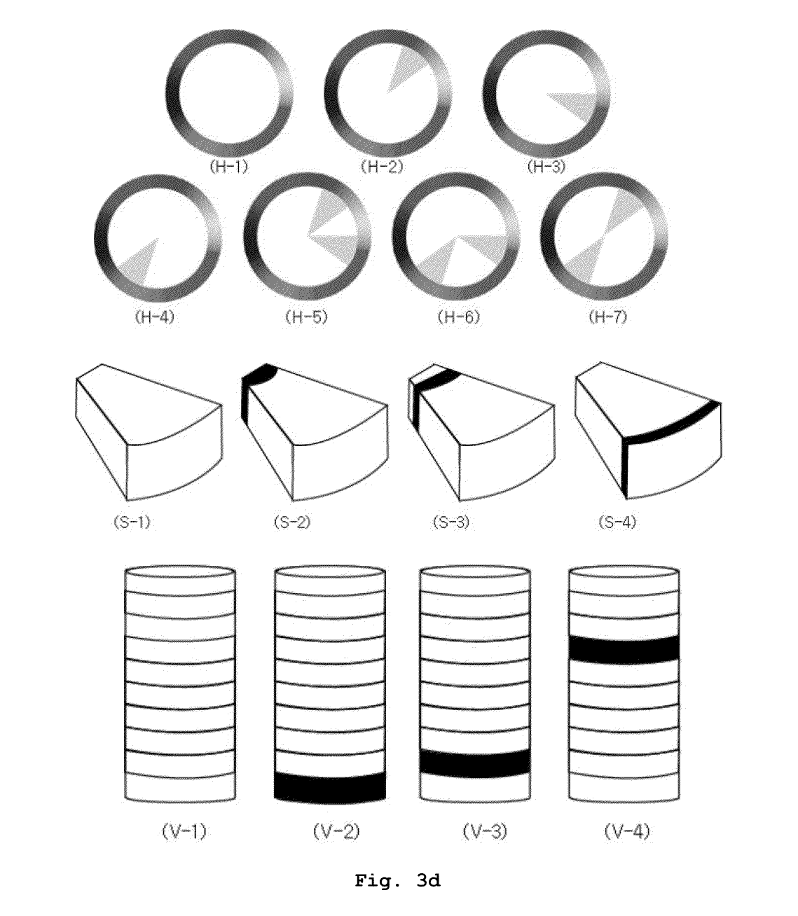

The initial individual creation and display at step S210 refers to a basic process to reflect a user's preference, and comprises an initial individual creation at step S211 and the display of an image at step S212. In the initial individual creation of step S211, individuals of N (positive integer) are created by selecting hue, saturation and brightness templates. The selected templates for each individual are applied to the original image and a color control for an image is performed by the image control method described above. The display of an image at step S212 shows a color controlled image. The step S210 will be described in detail later, referring to FIG. 6.

The user estimation and selection of step S220 refers to a process where a user's estimated value regarding the displayed color controlled image is received via a user interface, and an individual hand over to the next generation selected by selecting a tournament according to satisfaction and by using elitism. The user estimation and selection of step S220 comprises a user estimation of step S221, a determination made as to whether the user is satisfied with the color controlled image of step S222, and a selection of S233.

The user estimation of step S221 refers to a process to receive a user's estimated value regarding the displayed color controlled image. In an embodiment of the invention, a color controlled image by each individual may be estimated by various mechanisms, such as a user interface, etc. An example of the user interface is a slide button. Points may be formed with a number of levels. The input estimated values serve as values of suitability for a genetic algorithm. In addition, a dominant individual may be succeeded in the next generation according to a user's selection. The process of inputting a user's estimated value via a user interface will be described in detail later, referring to FIG. 6.

The determination of step S222 is made as to whether the user is satisfied with the color controlled image according to the user's estimated values received at step S221. When the user is satisfied with the color controlled image at step S222, the user estimation and selection of step S220 is terminated. On the contrary, when the user is not satisfied with the color controlled image at step S222, a genetic algorithm is computed based on the user's estimation and then the current process proceeds with a process to create the next generation individual.

The selection of step S233 refers to a process where an individual to be generated to the next generation is selected by selecting a tournament and by using elitism. The tournament selection is performed in such a manner that n individuals (n is a positive integer) is selected from the group and then an individual with the highest suitability remains. In an embodiment of the invention, n is set to two, and N individuals are selected by repeating the selection of tournament N times. The elitism is a method where the most dominant individual is selected and then handed over to the next generation.

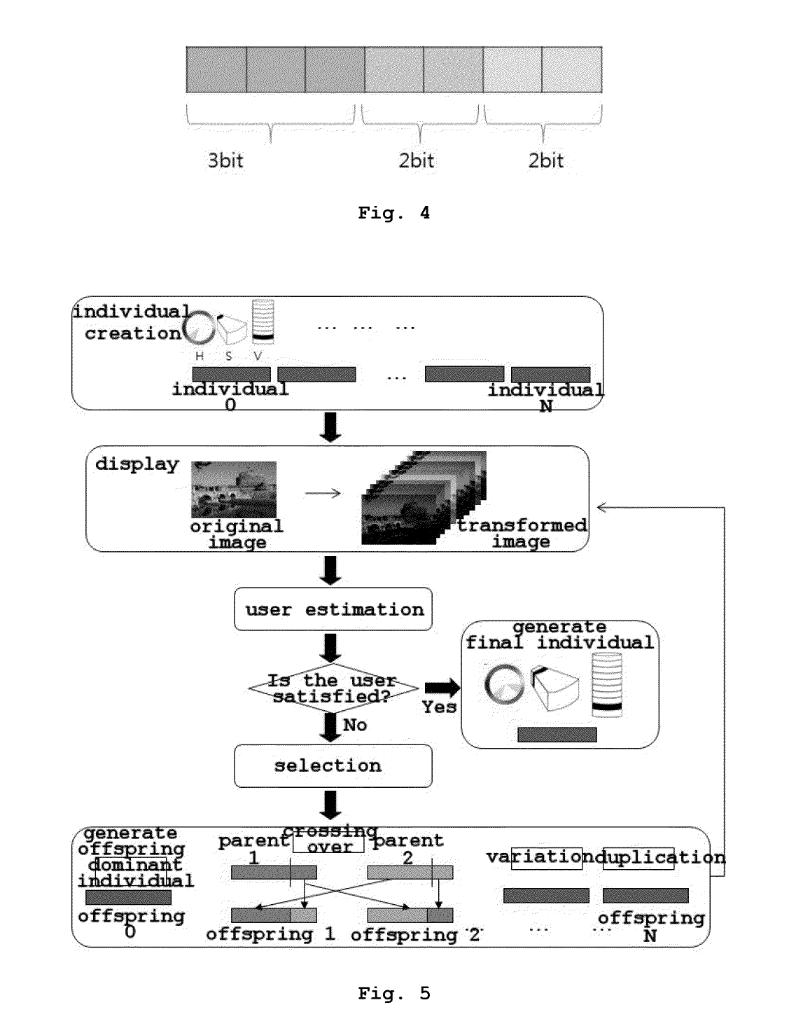

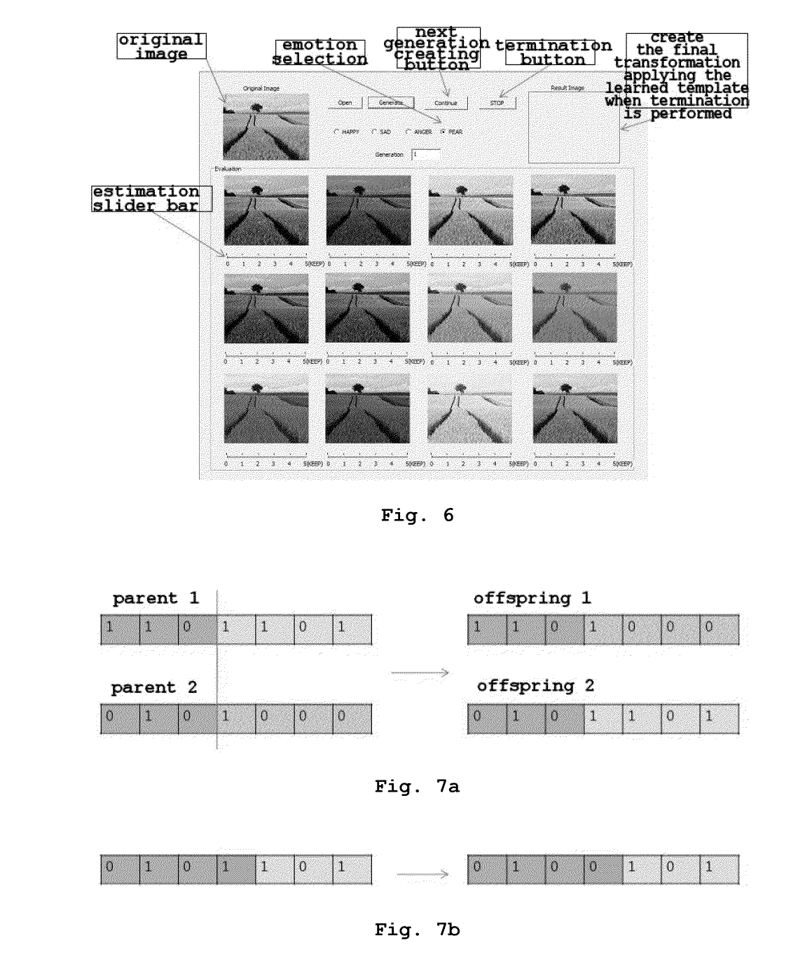

The next generation creation by operating a crossover and a variation of step S230 refers to a process where a genetic algorithm is computed to create an individual of the next generation when the user is not satisfied with the color controlled image at step S222 and thus the user estimation and selection of step S220 is not terminated. This process will be described in detail later, referring to FIG. 7.

In the determination of a combination of hue, saturation and brightness templates, serving as the final individual, based on a user's preference at step 240, the interactive genetic algorithm is terminated and then a color controlled image is created via a user preferred individual. When the user is satisfied with the color controlled image, the method is terminated, and then a combination of hue, saturation, and brightness templates, as the final individual reflecting a user's preference, is determined.

FIG. 6 illustrates a user interface according to an exemplary embodiment of the present invention.

As shown in FIG. 6, the user interface allows for the display of an original image and a color controlled image to which a template of an initially created individual is applied. The user interface allows a user to input his/her feelings and his/her estimated value regarding respective color controlled images. In an embodiment of the invention, the user interface allows for the estimation regarding the respective color controlled images at five levels via a slide button, and hands over a dominant individual selected by KEEP to the next generation. The user can create the next generation or terminate the method according to whether he/she is satisfied with the color controlled image. When the method is terminated, it creates the finally controlled image, to which a learned template is applied, and displays it.

FIG. 7A illustrates a view that describes a process of creating the next generation via a crossover operation, according to an exemplary embodiment of the present invention.

FIG. 7B illustrates a view that describes a process of creating the next generation via a variation operation, according to an exemplary embodiment of the present invention.

As shown in FIG. 7A, a spring individual can be created by a crossover operation with probability Pc. The crossover points are randomly selected. Although an embodiment of the invention is implemented in such a manner to perform a one point crossover operation, it should be understood that the invention is not limited thereto. For example, the embodiment may be modified in such a manner to cross over at two points. As shown in FIG. 7B, a bit of an individual may be modified with probability Pm. The modification of a bit makes it easier to change one of the hue, saturation and brightness templates. After performing the operation, the next generation is comprised of N individuals in total, which includes at least one selected from previous generation, dominant individuals, new individuals, created via the crossover operation and variation operation.

Experiment Result

An experiment is performed with controlling color by learning a user's preference based on an interactive genetic algorithm, using hue, saturation and brightness templates using various types of feelings defined according to an embodiment of the invention.

To carry out this experiment, a computer with CPU 2.20 GHz and memory of 2.0 GB is employed, and pictures from the website, www.flickr.com, are used. A user views 12 color controlled images using types of feelings and gives points to the images. A final template is determined by learning his/her preference based on his/her given points. When a new image and a feeling is input to the computer, a numerical formula is applied to the image and to thereby control color therein. At this stage, the input value may not be consistent with the controlled template. That is, if the type of feeling corresponds to sorrow, a pleasure template may be applied to the image in order to invoke a pleasurable feeling rather than maximize sorrow. In an embodiment of the invention, in order to prove the relationship between feeling and a color range of the proposed template, the experiment is performed in such a manner that the input feeling is consistent with a template to be controlled. In addition, the questionnaire survey for the preference of color controlled image has been conducted with respect to 15 students. This experiment ensures that the feeling-based image color controlling method according to the invention increases the user's level of image satisfaction. The questionnaire survey is conducted, using 15 new images that have never been used to learn the types of feelings.

In the experiment for controlling color a feeling-based image reflecting a user's preference based on an interactive genetic algorithm, the number of individuals, N, is set to 12, the crossover probability Pc to 0.8, and the variation probability Pm to 0.1. In addition, the number of generations is set to 10 in order to analyze the suitability by generations. γ1 and γ2 are set to 0.3 and 4.3 so that the image can be identified by avoiding being too light or unclear when saturation and brightness is controlled.

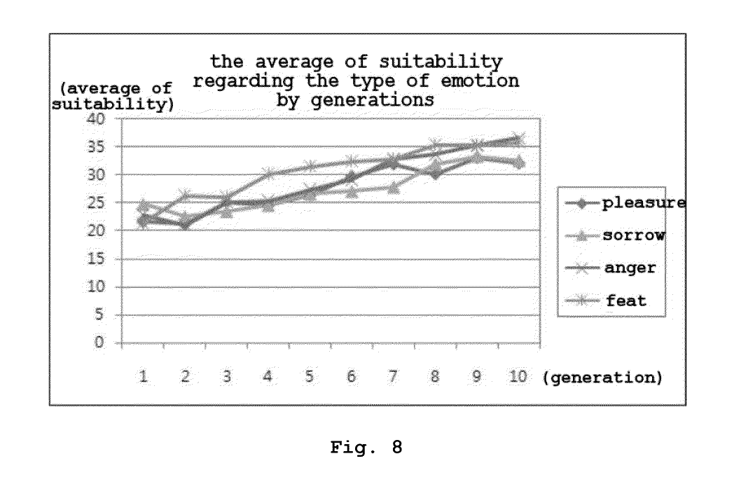

FIG. 8 is a plot of the average of suitability vs. generations with respect to feelings.

Referring to FIG. 8, the greater the number of generations the higher the suitability, i.e., a user's estimated point increases. This indicates that the more the generations repeat the more a combination of templates to meet a user's preference can be formed optimally.

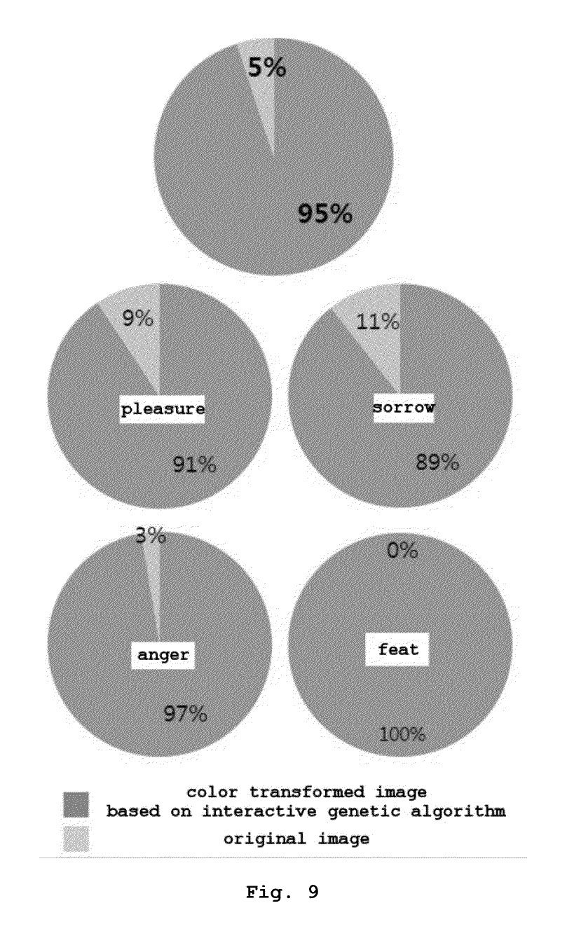

FIG. 9 is a diagram that shows a color controlled image preference for the four feelings, in the upper part, and a color controlled image preference by feelings.

Referring to FIG. 9, a color controlled image template by the interactive genetic algorithm with respect to the entire feeling shows a preference of 95%, and this result states that learning a user's preference has been effectively performed. In addition, the other results by types of feelings show preferences of 91%, 89%, 97%, and 100%, respectively.

As described above, the method for controlling the color of a feeling-based image reflecting a user's preference via an interactive genetic algorithm, according to the invention, can perform a color control in an image to meet a user's preference, thereby increasing a user's level of image satisfaction. The color control method can establish a relationship between color and feeling by defining color templates related to feelings, and can control color in an image according to a user's feelings. The color control method can define hue, saturation and brightness templates, and can increase a user's level of image satisfaction by controlling hue, saturation and brightness in an image. The color control method can apply an interactive genetic algorithm to a color controlling process in order to reflect a user's color preference, can learn a combination of a user's preferred templates, and can select a combination of final hue, saturation and brightness templates, thereby retaining a user's interest and absorption via the interactive process.

In addition, the color controlling method, according to the invention, can be applied to various areas. For example, the method can control color in contents, such as, animation, comics, games, etc. The method can also control color in characters or background in digital media arts, etc. The color controlling method of the invention can maximize an interaction according to a user's mutual response, so that the user can control the color in the contents. The color controlling method of the invention can also be applied to a search area, thereby efficiently perform a feeling-based search process. That is, the color controlling method can reflect a user's preference for respective learned feelings and can search images similar to the learned colors, thereby increasing in the user's level of image satisfaction for the search result.

While the invention has been shown and described with reference to certain exemplary embodiments thereof, it will be understood by those skilled in the art that various changes in form and detail may be made therein without departing from the spirit and scope of the invention as defined in the appended claims and their equivalents.

What is claimed is:

1. A method for controlling the color of a feeling-based image, comprising:
(1) defining a range of candidate colors by type of feelings as templates;
(2) selecting one from among the candidate templates, as the final template, by learning a user's color preference via an interactive genetic algorithm; and
(3) controlling the color of an image based on the final template by recognizing a user's feeling.

2. The method of claim 1, wherein the defining of the range of candidate colors comprises:
analyzing a relationship between color and feeling to determine a range of color reflecting respective feelings; and
defining the analyzed result as templates representing a range of colors corresponding to the respective feelings,
wherein the defined templates form a number of candidate templates to reflect the variety of relationship between color and feeling.

3. The method of claim 2, wherein each of the candidate templates comprises:
seven hue templates, four saturation templates, and four brightness templates.

4. The method of claim 1, wherein the selecting of one from among the candidate templates comprises:
creating an initial individual by selecting one of the defined templates, controlling the color of an image by applying the initial individual thereto, and displaying the color controlled image;
receiving a user's estimated value regarding the displayed color controlled image via a user interface, and selecting an individual to hand over to the next generation by selecting a tournament according to the user's level of image satisfactions and by using an elitism;
computing a one point cross with respect to a parent individual, and creating a variation by changing a bit; and
determining a combination of hue, saturation, and brightness templates for the final individual reflecting a user's preference.

5. The method of claim 1, wherein the controlling of the color of an image comprises:
controlling saturation and brightness by a gamma correction of an exponential transformation function as a nonlinearity function.
